(19) United States
(12) Patent Application Publication
(10) Pub. No.: US 2026/0113518 A1
(43) Pub. Date: Apr. 23, 2026

(54) DYNAMIC CONTENT DISTRIBUTION AND TRACKING

(71) Applicant: Learning Ninjas, Austin, TX (US)

(72) Inventor: Sarah Mercier, Olympia, WA (US)

(21) Appl. No.: 18/918,051

(22) Filed: Oct. 17, 2024

(51) Int. Cl. H04N 21/858; G06F 16/955

(52) U.S. Cl. CPC H04N 21/858; G06F 16/9558

(57) ABSTRACT

The present disclosure relates to systems and methods for the dynamic creation and distribution of content links, with an emphasis on tracking user interactions with digital content. The disclosed networked system can dynamically generate content links based on predefined configurations, including branding, xAPI verb mappings, and Learning Record Store (LRS) settings. These configurations are stored in a managed database and retrieved during content link generation. The system can further track user interactions by capturing event data and translating it into xAPI statements for storage in the LRS, thus enabling detailed analysis of user engagement.

### TECHNICAL FIELD

The disclosure is generally related to content distribution and management. More specifically, this disclosure is related to systems and methods for digital content dissemination as well as for tracking and monitoring interaction with digital content.

### BACKGROUND

Embodiments and implementations of the invention of the present disclosure are directed to systems and methods for dynamically creating, distributing, and tracking digital content that can optimize content delivery and enhance user interaction analytics. The embodiments described herein focus on managing content links and user engagement without requiring user account creation. The various implementations can also support comprehensive event tracking across diverse content types and facilitate the translation of user interactions into standardized xAPI statements for detailed analysis.

Traditionally, digital content distribution systems have relied heavily on centralized learning management systems (LMS) that require user accounts and complex interfaces. This approach has inherent limitations due to the barriers it creates for user access and the administrative burden of managing user accounts. Furthermore, traditional systems often lack the flexibility to integrate various content types seamlessly and to provide detailed analytics on user interactions. This limits the ability of organizations to deploy content efficiently and to gain insights into user engagement.

These conventional systems typically necessitate account creation and often operate within closed ecosystems, restricting the types of content that can be distributed and tracked. Additionally, they may not support dynamic customization of content presentation or the efficient use of local storage for personalizing user experiences. Moreover, the analytics provided by such systems are often limited to basic tracking metrics, failing to capture the full spectrum of user interactions.

In contrast, the embodiments described herein address these shortcomings by providing a flexible and scalable platform that enables dynamic creation and distribution of content links with customizable configurations. This includes the use of dynamic form rendering to collect user data without user accounts, leveraging local storage for data recall, and employing unique identifiers for anonymized user tracking.

Furthermore, the implementations and embodiments of the present disclosure distinguish themselves from existing digital content distribution systems by offering customizable translation of browser events into xAPI verbs. This versatility enables the systems described herein to adapt to various user interactions and content types, enhancing the accuracy and depth of user interaction analytics. This innovative approach is particularly beneficial for organizations seeking to deploy training and educational content efficiently while maintaining detailed oversight of user engagement.

The implementations of the present disclosure thus represent a significant advancement in the field of digital content distribution and tracking, offering a more adaptable and user-friendly solution than currently available technologies. The embodiments disclosed herein enable secure communication, efficient content delivery, and comprehensive tracking and analysis of user interactions, thereby enhancing both the deployment and evaluation of digital content.

### SUMMARY

The various implementations and embodiments of the invention described in more detail below can include systems, methods, and non-transitory machine-readable storage media including instructions for digital content link creation and digital content distribution and tracking. Accordingly, in some embodiments the networked system for dynamically creating digital content links and for distributing and tracking digital content can include an Application Server (AS) communicatively connected to an Administrative User Device (AUD), a Public User Device (PUD), a Content Storage Device (CSD), a Managed Database (MDB), and a Learning Record Store (LRS). In these and other embodiments the AS can access the MDB to retrieve stored link profile configuration settings and the AS can cause a form to be generated dynamically based on the link profile configuration settings. Furthermore, in the various embodiments, the AS can cause the PUD to determine whether or not a local non-volatile memory location associated with a browser of the PUD includes a data item having one or more values previously respectively entered into one or more corresponding fields of the form. In several embodiments, responsive to determining that the local non-volatile memory location associated with a browser of the PUD includes the data item having the one or more values previously entered into the corresponding field, the AS causes the PUD to pre-populate the one or more corresponding fields with the one or more values respectively. In some embodiments, the AS can cause the PUD to retrieve the digital content from a location identified by a specified content link, and the AS can also cause the PUD to monitor and detect events as they occur during content interaction. In these and other embodiments, the AS can transmit xAPI verb mappings specified in the link profile configuration settings for the PUD to translate the detected events into xAPI statements and transmit them to the LRS.

In some implementations described herein that pertain to a method, the method for dynamically creating digital content links and for distributing and tracking digital content in a networked system can include accessing, by an Application Server (AS), a Managed Database (MDB) to retrieve corresponding stored link profile configuration settings and can include causing, by the AS, a form to be dynamically generated based on the link profile configuration settings. In these and other implementations, the method can include causing a Public User Device (PUD) to determine whether a local non-volatile memory location associated with a browser of the PUD comprises a data item containing one or more values previously entered into corresponding fields of the form, and causing, by the AS, the form to be pre-populated by the PUD with the one or more values in response to determining that the local non-volatile memory comprises the data item containing the one or more values previously entered into corresponding fields of the form. In several implementations, the method can also include uploading, by the AS, content to a Content Storage Device (CSD) in response to content submission from the AUD, storing, by the AS, an external content link in the MDB in response to an external content link submission from the AUD, and generating, by the AS, the specified content link associated with the two or more data categories in response to completion of the link profile configuration by the AUD. In some implementations, the method can include transmitting, by the AS, instructions to the PUD for accessing the digital content by the PUD, and causing, by the AS, and Event Tracking Listener to be executed on the PUD to monitor and detect events as they occur during content interaction. In these and other implementations, the method can also include causing, by the AS, a Recipe Translator to be executed on the PUD to translate the detected events into xAPI statements based on xAPI verb mappings specified in the link profile configuration settings, and causing, by the AS, the xAPI statements to be transmitted from the PUD to a Learning Record Store (LRS) for storage and reporting.

Some implementations and embodiments described herein relate to a non-transitory machine-readable medium that includes instructions that, when executed, causes a processing device to perform operations. For example, a non-transitory machine-readable storage medium can include instructions that, when accessed by a processing device, cause the processing device to access a Managed Database (MDB) to retrieve corresponding stored link profile configuration settings and cause the processing device to cause a form to be dynamically generated based on the link profile configuration settings. In these and other implementations and embodiments, the non-transitory machine-readable storage medium can include instructions that, when accessed by a processing device, cause the processing device to determine whether a local non-volatile memory location associated with a browser of a Public User Device (PUD) comprises a data item containing one or more values previously entered into corresponding fields of the form, and cause the processing device to pre-populate the form with the one or more values in response to determining that the local non-volatile memory comprises the data item containing the one or more values previously entered into corresponding fields of the form, as well as cause the processing device to generate the form in response to receiving a content link request from the PUD. In several implementations and embodiments, the non-transitory machine-readable storage medium can include instructions that, when accessed by a processing device, cause the processing device to process form input data and use the at least one value to associate the form input data with the specified public user's session for tracking interactions with the content, and cause the processing device to retrieve content from either a Content Storage Device (CSD) or a Content Delivery Network (CDN) in response to form submission by the PUD. In these and other implementations and embodiments, the non-transitory machine-readable storage medium can include instructions that, when accessed by a processing device, cause the processing device to monitor and detect events during content interaction through an Event Tracking Listener executed on the PUD, to receive event data for each event, wherein the event data includes interaction type, timestamp, and any relevant metadata, as well as cause the processing device to translate the detected events using a Recipe Translator, wherein the Recipe Translator maps each event to a predefined xAPI verb and combines it with the one or more values to generate a complete xAPI statement, so that the processing device can store the xAPI statement in a Learning Record Store (LRS).

These and other elements and features will become more clear in the following detailed description of illustrative implementations and example embodiments of the disclosure, which is to be read in connection with the accompanying drawings.

### BRIEF DESCRIPTION OF THE DRAWINGS

The disclosure is illustrated by way of examples, and not by way of limitation, and may be more fully understood with references to the following detailed description when considered in connection with the figures, in which:

FIG. 1 depicts a schematic block diagram of an example networked system architecture, in accordance with one or more embodiments of the present disclosure;

FIG. 2 depicts a schematic block diagram of an example networked system architecture, in accordance with one or more embodiments of the present disclosure;

FIG. 3 illustrates a flow diagram of an example method for content link creation and content tracking and monitoring, in accordance with one or more embodiments of the present disclosure;

FIG. 4 shows a schematic block diagram of an example content launching and interaction tracking process in a system, in accordance with one or more embodiments of the present disclosure;

FIG. 5 shows a schematic block diagram of an example content launching and interaction tracking process in a system, in accordance with one or more embodiments of the present disclosure;

FIG. 6 depicts a block diagram of an example computer system in accordance with one or more embodiments of the present disclosure; and

FIG. 7 depicts a block diagram of an illustrative computing device operating in accordance with one or more embodiments of the present disclosure.

### DETAILED DESCRIPTION

Described herein are systems and methods for dynamic content distribution and tracking. Implementations of such systems and methods can optimize content delivery and enhance user interaction analytics without necessitating user account creation. Traditionally, digital content distribution systems relied on centralized learning management systems (LMS) that required user accounts and complex interfaces. These systems posed significant limitations, including barriers to user access and administrative burdens associated with managing user accounts. Moreover, traditional systems often lacked the flexibility to seamlessly integrate diverse content types and provide comprehensive analytics on user interactions, thereby impairing organizations'ability to efficiently deploy content and gain insights into user engagement.

The present embodiments and implementations offer a significant technical improvement by providing a flexible and scalable platform that enables dynamic creation and distribution of content links with customizable configurations. This includes the use of dynamic form rendering to collect user data without user accounts, leveraging local storage for data recall, and employing unique identifiers for anonymized user tracking. As a result, organizations can efficiently deploy training and educational content while maintaining detailed oversight of user engagement.

The disclosures described herein introduce innovative systems and methods designed for the dynamic distribution and tracking of digital content across diverse platforms. These systems facilitate the translation of user interactions into standardized xAPI statements for detailed analysis, enhancing the accuracy and depth of user interaction analytics. The novel approach supports comprehensive event tracking across various content types, addressing the limitations of traditional systems and offering a more adaptable and user-friendly solution.

In this context, the present disclosure seeks to address the challenges faced when deploying digital content in a manner that optimizes user engagement and interaction analytics. By eliminating the need for user account creation and supporting dynamic customization of content presentation, the disclosed systems and methods enable efficient content delivery and detailed user interaction tracking.

The various embodiments and implementations of the inventive systems and methods operates through several high-level stages that streamline the process of dynamic content distribution and tracking. Initially, in some embodiments, the system can begin by accessing (e.g., through the actions of an Application Server (AS)) a Managed Database (MDB) to retrieve stored link profile configuration settings. These configuration settings can include data categories such as branding data, LRS configuration, xAPI verb mapping, form field configurations, and content metadata. This retrieval process can help ensure that the content link is tailored to meet specific requirements outlined by an Administrative User Device (AUD).

Once the configuration settings are retrieved, some embodiments can dynamically generate a user-friendly form based on these configurations. This form can then be sent to a Public User Device (PUD), which determines whether any previously entered data values exist in its local non-volatile memory location. If such data is found, the system can automatically pre-populate the form fields with these values, enhancing user experience by minimizing repetitive data entry and reducing redundancy.

Upon the submission of the form by the PUD, the system can retrieve the digital content from a specified content link. Depending on the content's origin, this retrieval may occur from a Content Storage Device (CSD) for directly uploaded content, from a Content Delivery Network (CDN) for optimized delivery of cached content, or from an external source if the content is linked externally. This flexibility ensures efficient and reliable content delivery across various platforms.

During content interaction, an Event Tracking Listener on the PUD can be activated to monitor and detect user interactions in real time. This listener can capture a variety of events, such as play, pause, and content completion, that are useful for understanding user engagement. The detected events, along with associated metadata like timestamps and unique user identifiers, can then be processed by a Recipe Translator executed on the PUD.

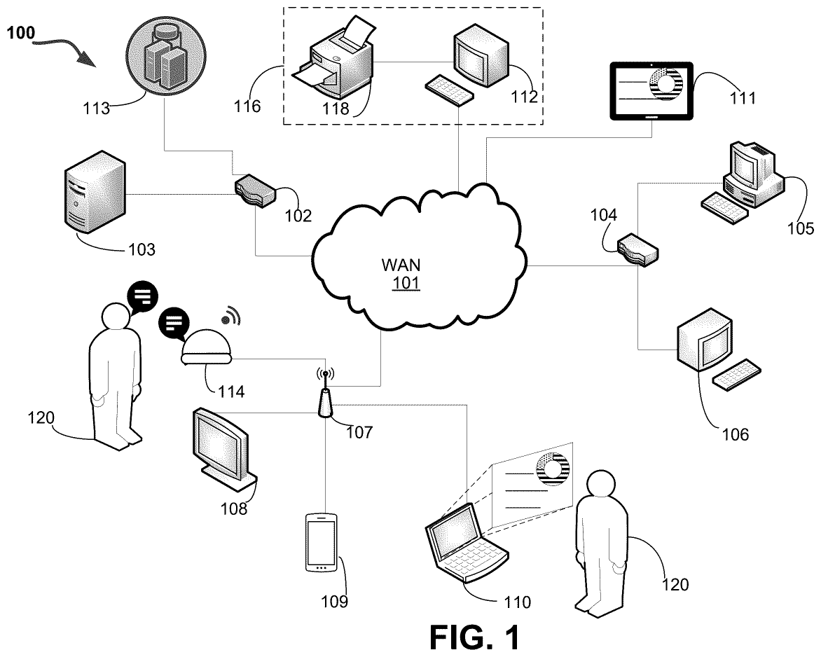

The Recipe Translator can map each detected event to predefined xAPI verbs, converting them into comprehensive xAPI statements. These statements can be enriched with metadata and user identifiers to provide a detailed account of the user's interaction with the content. The xAPI statements can then be securely transmitted to a Learning Record Store (LRS) (e.g., via secure API calls), where they can be stored for detailed reporting and analysis. This process can enable organizations to gain in-depth insights into user behavior and learning, facilitating the evaluation and enhancement of digital content strategies. By leveraging these innovative systems and methods, organizations can achieve a higher level of engagement analysis while streamlining content distribution processes. These and other features and aspects of the various embodiments and implementations of the present disclosure are described below with reference to FIGS. 1-7.

FIG. 1 depicts a schematic block diagram of an example networked system architecture 100, in accordance with one or more embodiments of the present disclosure. For example, in some embodiments, the system can include of one or more application servers 103 for electronically storing information used by the system and/or server clusters 113 for processing and outputting the information used by the system. For example, an application for dynamically creating digital content links and for distributing and tracking digital content can be hosted on one or more application servers 103 or server clusters 113. In other examples, dynamically creating digital content links and for distributing and tracking digital content can be executed on a computing device 108, 109, 110, 114. Applications in the server 103, server clusters 113, or computing device 108, 109, 110, 114 can retrieve and manipulate information in storage devices and exchange information through a WAN 101 (e.g., the Internet). Applications in server 103, server clusters 113, or computing device 108, 109, 110, 114 can also be used to manipulate information stored remotely and process and analyze data stored remotely across a WAN 101 (e.g., the Internet). For example, in some embodiments, an application in server 103, server cluster 113, or computing device 108, 109, 110, 114 can receive, transmit, access, edit, and delete information that is located on other devices in the system or cause the data to be processed by other devices.

According to an example embodiment, exchange of information through the WAN 101 or other network can occur through one or more high speed connections. In some cases, high speed connections can be over-the-air (OTA), passed through networked systems, directly connected to one or more WANs 101 or directed through one or more routers 102. One of ordinary skill in the art would appreciate that there are numerous ways that server 103 can connect to WAN 101 for the exchange of information, and various embodiments of the present disclosure are contemplated for use with any method for connecting to networks for the purpose of exchanging information. Further, while this description refers to high speed connections, embodiments of the present disclosure can be utilized with connections of any speed.

Components, elements, or modules of the system can connect to server 103 or cluster 113 via WAN 101 or another network in various ways. For instance, a component or module can connect to the system (i) through a computing device 112 directly connected to the WAN 101, (ii) through a computing device connected to the WAN 101 through a routing device 102, 104, (iii) through a computing device 108, 109, 110, 114 connected to a wireless access point 107, or (iv) through a computing device 111 via a wireless connection (e.g., WiFi, CDMA, GMS, 3G, 4G, 5G, other suitable means, and means not yet invented) to the WAN 101. One of ordinary skill in the art will appreciate that there are numerous ways that a component, module, of the system can connect to server 103 via WAN 101 or another network, and embodiments of the present disclosure are contemplated for use with any method for connecting to server 103 via WAN 101 or another network. Furthermore, in some embodiments, server 103 can itself be, include, or be hosted on a personal computing device, such as a smart phone 109 or tablet 111, acting as a host for other computing devices to connect to. In several embodiments, server 103, cluster 113, laptop 110, personal computer 108, 106, 112, virtual machine 105, cell phones/smart phones 109, tablets 111 can likewise host a server or execute the application.

Users 120 of the system in accordance with embodiments of the present disclosure can interact with the system via computing devices such as a laptop 110, personal computer 108, 106, 112, virtual computer 105, cell phones/smart phones 109, tablets 111, smart speakers 114, smart TVs, smart hubs, smart kiosks, and the like. Each of the steps and actions described herein can be performed via the input and output means of these respective devices including

For example, a user 120 can operate a tablet 111 or laptop 110 to navigate to a browser interface presenting a web-based version of the software interface of the present disclosure and be presented with interactive elements on the screen of the laptop 110 or the user can provide inputs to the system via the touchscreen of the tablet 111. In other embodiments, a user 120 can operate smart speaker 114 to enter data and information through voice prompts and an interactive conversational process in a question-answer or prompt-response audio format.

Consequently, in some embodiments, data representative of information about a user (e.g., a user's name, identifier, or contact information) can be input via a dynamically generated form rendered on a user device such as personal computer 108, 106, 112, virtual machine 105, smart phones 109, tablet 111 which can then transmit it to another device or component of the system (e.g., server 103). For example, smart phone 109 can transmit this information together with a request to an application server such as server 103.

In some embodiments, the tablet 111 can provide controls and interfaces that send user input to processed on a remote device such as a server 103 or cluster 113. It should be understood that the user 120 can interact with the software interface of the present disclosure by engaging user interface elements and entering input through a touch-screen of the tablet 111. Alternatively, in an embodiment of the present disclosure incorporating an audio device such as a smart speaker 114, a user can initialize an audio software interface to receive audio output and provide audio input to interact with the interface elements.

In one embodiment of the present disclosure, the networked system for dynamically creating digital content links and for distributing and tracking digital content can include an application server (AS) (e.g., application server 103) that is communicatively connected to an Administrative User Device (AUD) (e.g., tablet 111), a Public User Device (PUD) (e.g., laptop 110), a Content Storage Device (CSD), a Managed Database (MDB), and a Learning Record Store (LRS). In some embodiments, in response to receiving a link profile request from an AUD to create or modify a specified content link, the application component running on the AS can access the MDB to retrieve corresponding stored link profile configuration settings that include two or more data categories, and can send this configuration data back to the AUD. In instances where the link profile request is made to create a specified content link, the application component running on the AS can access the MDB to retrieve link profile configuration settings that can be modified so that the specified content link can be created on the basis of those profile configuration settings.

In these and other embodiments, in response to the completion of link profile configuration adjustment by the AUD, the application component running on the AS can generate the specified content link. When a content link request is received, the application component running on the PUD can dynamically generate a form based on the link profile configuration settings stored in the MDB, where the form includes a variety of form fields. In several embodiments, the application component running on the PUD can determine whether a local non-volatile memory location associated with a browser of the PUD contains a data item with one or more values previously entered into corresponding fields of the form fields, with at least one value being associated with a specified public user's session for content linked to the specified content link. These one or more values can include a unique user identifier (UUID) that was previously assigned and automatically entered by the application component running on the PUD to identify the specified public user's session of interacting with the content linked to the specified content link.

In some embodiments, responsive to the application component running on the PUD determining that the local non-volatile memory location associated with a browser of the PUD contains the data item with the one or more previously entered values (e.g., determines that the data item contains a previously assigned UUID), the application component running on the PUD can pre-populate the corresponding fields with these values. In response to form submission, the application component running on the PUD can then retrieve the digital content from the location identified by the specified content link. In these and other embodiments, the application component running on the PUD can monitor and detect events as they occur during content interaction and can use the xAPI verb mappings specified in the link profile configuration settings to translate the detected events into xAPI statements. In several embodiments, the application component running on the PUD can transmit the generated xAPI statements to the LRS and request the LRS to acknowledge receipt of the xAPI statements upon receiving them, and further request the LRS to store the xAPI statements in a data repository.

The communications means of the system, according to embodiments of the present disclosure, can be any means for communicating data, including image and video, over one or more networks or to one or more peripheral devices attached to the system, or to a system module or component. Appropriate communications means can include, but are not limited to, wireless connections, wired connections, cellular connections, data port connections, Bluetooth® connections, or any combination thereof. One of ordinary skill in the art will appreciate that there are numerous communications means that can be utilized with embodiments of the present disclosure, and embodiments of the present disclosure are contemplated for use with any communications means

Traditionally, a computer program includes a finite sequence of computational instructions or program instructions. It will be appreciated that a programmable apparatus or computing device can receive such a computer program and, by processing the computational instructions thereof, produce a technical effect. It should be understood that a programmable apparatus or computing device can include one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this specification and elsewhere, a computing device can include any and all suitable combinations of at least one general purpose computer, special-purpose computer, programmable data processing apparatus, processor, processor architecture, and so on. It will be understood that a computing device can include a computer-readable storage medium and that this medium can be internal or external, removable and replaceable, or fixed. It will also be understood that a computing device can include a Basic Input/Output System (BIOS), firmware, an operating system, a database, or the like that can include, interface with, or support the software and hardware described herein

Embodiments of the system as described herein are not limited to applications involving conventional computer programs or programmable apparatuses that run them. It is contemplated, for example, that embodiments of the present disclosure as claimed herein could include an optical computer, quantum computer, analog computer, or the like

Any combination of one or more computer readable medium(s) can be utilized with the various embodiments of the present disclosure. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. Illustrative examples of the computer readable storage medium can include the following: an electrical connection having one or more wires, a portable computer diskette, a hard disk, floppy disks, optical disks (such as Blu-Ray disks, DVDs), CD-ROMs, and magnetic-optical disks, solid-state drives (SSDs), flash memory devices (including USB flash drives and SD cards), read-only memories (ROMs), random access memories (RAMs), dynamic random access memories (DRAMs), synchronous dynamic random access memories (SDRAMs), electrically erasable programmable read-only memory (EEPROMs), magnetoresistive random-access memories (MRAMs), ferroelectric RAM (FRAM), Phase-change memory (PCM), optical cards, a memory stick, three-dimensional (3D) XPoint and other non-volatile memory, a mechanically encoded device such as punch-cards or raised structures in a groove having instructions recorded thereon, and any suitable combination of the foregoing.]]

A data store can include one or more of a database, file storage system, relational data storage system or any other data system or structure configured to store data. The data store can be a relational database, working in conjunction with a relational database management system (RDBMS) for receiving, processing and storing data. For example, databases that embodiments of this disclosure can employ can be relational databases such as MySQL, PostgreSQL, Oracle Database, Microsoft SQL Server, and SQLite, each offering robust support for structured data and SQL queries. Analogously, in some embodiments, non-relational databases like MongoDB, Apache Cassandra, Google Firestore, Amazon DynamoDB, Couchbase, Hbase, big-table, and Neo4j, which are optimized for scalability, flexibility, and the efficient handling of unstructured or semi-structured data, can be used. A data store can include one or more databases for storing information related to the processing of moving information and estimate information as well one or more databases configured for storage and retrieval of moving information and estimate information.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Computer readable program instructions described herein can be downloaded to respective computing/processing devices from a computer readable storage medium or to an external computing device or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The flowchart and block diagrams in the Figures illustrate the architecture, functionality, and operation of possible implementations of systems, methods, and computer program products according to the various embodiments hereof. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the figures.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. An additional detailed explanation of an example networked system architecture according to the various implementations of this disclosure is provided in the following description.

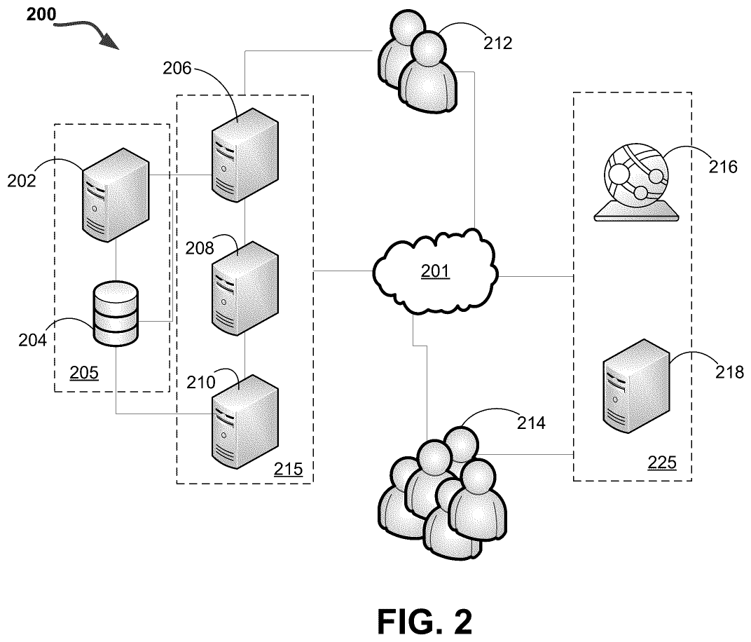

FIG. 2 depicts a schematic block diagram of an example networked system architecture 200, in accordance with one or more embodiments of the present disclosure. In some of these embodiments, the networked system for dynamically creating digital content links and for distributing and tracking digital content includes an application server (AS) 202 that is communicatively connected (e.g., through a network 201 such as the internet) to an Administrative User Device (AUD) 206, a Public User Device (PUD) 210, a Content Storage Device (CSD) 208, a Managed Database (MDB) 204, a Content Delivery Network (CDN) 216, and a Learning Record Store (LRS) 218. These components collectively form an integrated networked system where each element plays an important role in ensuring efficient content management and provides insightful user interaction analytics. In the various embodiments the AS 202 and MDB 204 can be cloud computing resources 205. This cloud-based configuration allows for enhanced data accessibility, redundancy, and scalability, which are useful for managing dynamic and varied content loads. In these and other embodiments, the AUD 206, the CSD 208, and the PUD 210 can be static servers 215 or discretely defined computing devices. This flexibility ensures that the system can be adapted to different organizational needs, whether it be on-premises servers or distributed cloud environments. For example, the AUD 206 can be a device accessible to administrative users 212 while PUD 210 can be a device accessible to public users 214 (i.e., content link users that interact with the digital content). This segregation of devices based on user roles ensures that administrative functions and content consumption are securely and efficiently managed. In some embodiments, the AS 202 can manage link profiles and content distribution by interacting with the AUD 206 to create or modify specified content links while the PUD 210 can access and interact with digital content and the CSD 208 is used for storing the digital content. In these and other embodiments, the MDB 204 can store link profiles, user data, and metadata, the CDN 216 can be used to efficiently host and serve digital content, and the LRS 218 can store xAPI statements generated from user interactions. The CDN and LRS 218 can be third-party devices 225 or services.

In several embodiments, in response to receiving a link profile request from the AUD, the AS 202 can access the MDB 205 to retrieve corresponding stored link profile configuration settings (i.e., the configuration settings that control how a dynamic form is generated and rendered on the PUD 210, how digital content is retrieved and accessed, and how interactions with the digital content are monitored and tracked). This access process involves querying the MDB 204, which serves as a centralized repository, ensuring that all necessary configuration data is up-to-date and reflects the latest adjustments made by administrative users. The link profile request can be communicated via a secure (e.g., HTTPS) connection from the AUD 206 to the AS 202. This secure transmission is crucial to maintaining the integrity and confidentiality of the data, preventing unauthorized access or interception during the communication process. These settings can include two or more data categories such as branding data (e.g., logos, accent colors, and layout options for the form), LRS 218 configuration data (e.g., data specifying the LRS 218 endpoint, authentication credentials, and any related API details for sending xAPI statements), xAPI verb mapping data (e.g., data defining how specific browser events such as play, pause, and complete are translated into xAPI verbs like “Started”, “Paused”, “Completed”), form field configuration data (specifying the input fields like name, email, user ID, random UUID to be presented to public users in the form, including whether fields are required or optional and the data types allowed such as text, email, numeric), and content metadata (including a human-readable content title, description, and unique identifier associated with the link profile and the content link itself). Each data category plays a distinct role in tailoring the user experience and ensuring accurate tracking of user interactions, which is critical for detailed analytics and reporting. In these and other embodiments, the AS 202 can send this configuration data back to the AUD 206 over a secure (e.g., HTTPS) connection. This return transmission ensures that the AUD 206 receives the latest configuration settings, allowing administrative users to review and confirm the configurations before proceeding with content distribution, thereby maintaining a consistent and secure content delivery process.

In response to digital content submission from the AUD 206, the AS 202 can upload the corresponding content to the CSD. Alternatively, in response to an external content link submission from the AUD, the AS 202 can store the external content link in the MDB 204. This allows the system to maintain a reference to externally hosted resources, enabling efficient retrieval without duplicating data storage. In several embodiments, based on the content type, the AS 202 can either store the content internally or cache it in the CDN 216 to ensure optimized content delivery to public users. Caching content in a CDN enables rapid access and distribution by leveraging geographically distributed servers, which reduces latency and improves load times for end users.

In response to the completion of link profile configuration adjustment by the AUD 206, the AS 202 can generate the specified content link, associating it with branding elements, form field configurations, LRS 218 settings, and the content location (either in the CSD 208 or external link). This association process involves compiling metadata and configuration parameters into a cohesive data object that can be efficiently managed and accessed. In some embodiments, the AS 202 can send the generated content link back to the AUD 206 for distribution. This return transmission allows administrative users to disseminate the content link through various communication channels, ensuring the content reaches its intended audience.

In response to receiving a content link request from the PUD 210, the AS 202 can cause a form to be generated dynamically based on the link profile configuration settings stored in the MDB 204, where the form includes a plurality of form fields. This dynamic generation involves retrieving stored settings and applying them to create a tailored user interface, which facilitates the collection of specific data points from the end user. In these and other embodiments, the AS 202 can retrieve the relevant form fields, branding elements, and metadata associated with the content link, and dynamically generate the form, which is then sent to the PUD 210 for display. This ensures that the user interface aligns with the branding and functional requirements specified by the administrative user, enhancing user experience.

The AS 202 can cause the PUD 210 to determine whether a local non-volatile memory location associated with a browser of the PUD 210 contains a data item with one or more values previously entered into corresponding fields of the form fields, with at least one value being associated with a specified public user's session for content linked to the specified content link. This determination process involves querying the browser's local storage to identify any pre-existing data that can be utilized to streamline the user interaction process. These one or more values can include a unique user identifier (UUID) that was previously assigned and automatically entered by the application component running on the PUD 210 to identify the specified public user's session of interacting with the content linked to the specified content link. The use of a UUID facilitates precise tracking of user interactions while maintaining user anonymity. For example, if a UUID was previously assigned to the specified public user's session for interacting with the content and automatically entered into the corresponding form field, the local non-volatile memory location associated with the browser of the PUD 210 can contain a data item with that UUID. This ensures continuity in user sessions across multiple interactions with the system. In response to determining that the local non-volatile memory location contains the data item with the previously entered values, the AS 202 can cause the PUD 210 to pre-populate the corresponding fields with these values to reduce redundancy. This pre-population minimizes user effort and potential errors during data entry, thereby enhancing the overall user experience.

In response to form data submission, the AS 202 can cause the PUD 210 to process the form input data and associate it with the specified public user's session for tracking interactions with the content. This association can be facilitated by linking the form data to a unique session identifier, which allows the system to maintain continuity and context across user interactions. In several embodiments, the AS 202 can cause the PUD 210 to retrieve the digital content from a location identified by the specified content link, whether from the CSD 208 if the content was uploaded directly by the admin, from the CDN 216 for optimized delivery if the content is cached there, or from an external source if the content is linked externally. This retrieval process can help ensure that public users 214 have seamless access to content regardless of its storage location, optimizing both load time and resource allocation.

In these and other embodiments, the AS 202 can cause the PUD 210, through an Event Tracking Listener executed on the PUD 210, to monitor and detect events as they occur during content interaction. The Event Tracking Listener can operate by intercepting and analyzing user actions, such as clicks, scrolls, and media controls, to gather comprehensive interaction data. The AS 202 can also cause the PUD 210 to execute the Event Tracking Listener to monitor and detect these events. This execution ensures that real-time data on user engagement is captured accurately, providing valuable insights into content interaction patterns.

In several embodiments, the PUD 210 can transmit event data for each event to the LRS 218, where the event data can include a unique user identifier, an interaction type, a timestamp, and various types of metadata (e.g., any relevant metadata). This transmission allows for the systematic organization of interaction data, facilitating subsequent analysis and reporting. In response to receiving a content link request from the PUD 210, the AS 202 can transmit xAPI verb mappings specified in the link profile configuration settings to the PUD 210 and cause the PUD 210 to use those mappings to translate, using the Recipe Translator, the detected events into xAPI statements. These mappings provide a structured framework for converting raw event data into a standardized format, ensuring consistent data representation across different interactions with the digital content.

For example, the AS 202 can cause the PUD 210 to execute the Recipe Translator to translate the detected events, where the Recipe Translator maps each event to a predefined xAPI verb and combines it with one or more values, including the unique user identifier, to generate a complete xAPI statement. The translation process involves assigning each detected event a corresponding xAPI verb that accurately reflects the nature of the interaction. In these embodiments, upon receiving event data, the Recipe Translator can map each event to a predefined xAPI verb (e.g., “Started,” “Paused,” “Completed”) and combine it with the one or more values to generate a complete xAPI statement. This ensures that each user interaction is comprehensively documented, providing a detailed record suitable for advanced analytics.

In some embodiments, the AS 202 can also cause the PUD 210 to transmit the generated xAPI statements via secure API calls to the LRS 218. The AS 202 can further cause the PUD 210 to use the LRS 218 for storing and managing user interaction data related to the content. The LRS 218 serves as a centralized repository where xAPI statements are stored, enabling efficient access and retrieval for reporting and analysis. In these and other embodiments, the AS 202 can cause the PUD 210 to request the LRS 218 to acknowledge receipt of the xAPI statements in response to receiving them and to request the LRS 218 to store the xAPI statements in a data repository. This acknowledgment and storage process ensures data integrity and availability for ongoing and future analytic processes. These processes streamline the data management workflow by ensuring secure transmission and storage of interaction data, marking a significant advancement over conventional methods. The ability of the various embodiments to dynamically generate xAPI statements and integrate them with the LRS 218 exemplifies a technical improvement that enhances both data accuracy and user engagement insights. By eliminating the need for traditional user accounts and supporting diverse content types, this approach provides a more adaptable and user-friendly solution for digital content tracking. More detailed explanations of the operation of example systems and the actions and steps performed by the various components according to the various embodiments and implementations of this disclosure are provided in the following description.

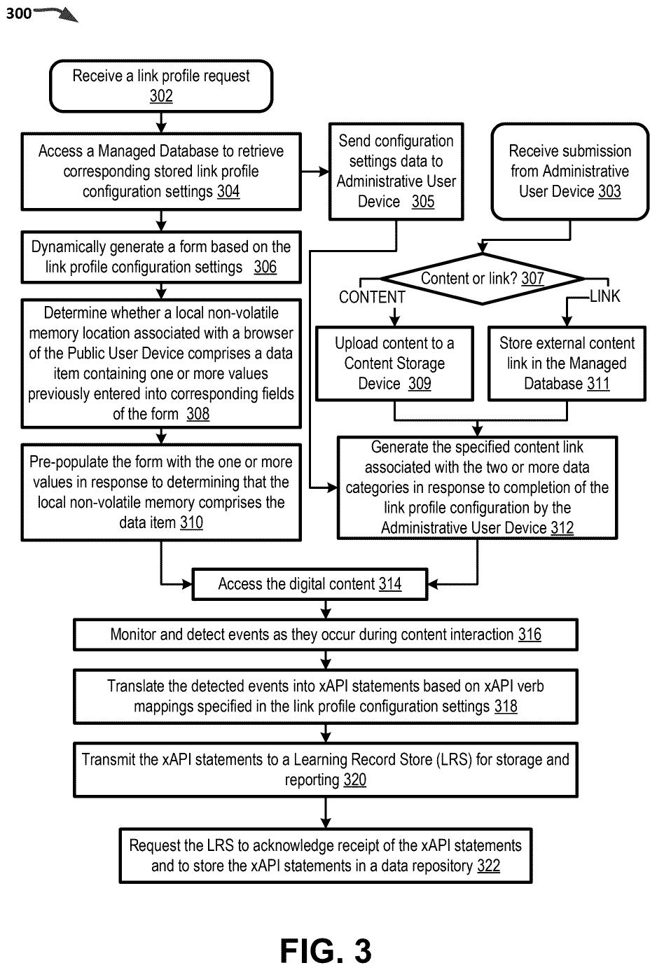

A flow diagram of an example method 300 for content link creation and content tracking and monitoring according to some embodiments and implementations of the present disclosure is described with reference to FIG. 3 and continued reference to FIGS. 1-2. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 can be performed by one more computing components or processing devices described earlier with reference to FIGS. 1-2. For example, in some embodiments, one or more steps, operations, or actions of the method 300 can be performed by the server 103, cluster 113, laptop 110, personal computer 108, 106, 112, virtual machine 105, cell phone/smart phone 109, or tablet 111 of FIG. 1 while in the same or other embodiments, one or more steps, operations, or actions of the method 300 can be performed by the AS 202, AUD 206, or PUD 210 of FIG. 2. It should be understood that one component of the embodiments described herein can cause another component to perform any of the described actions. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible and are contemplated by this disclosure without each being individually described.

In some implementations, at block 302 the processing logic can receive a link profile request, and in response, can, at block 304, access a MDB 204 to retrieve corresponding stored link profile configuration settings. In these and other implementations, at block 306, the processing logic can dynamically generate a form to be dynamically based on the link profile configuration settings, and can, at block 308, determine whether a local non-volatile memory location associated with a browser of the PUD 210 comprises a data item containing one or more values previously entered into corresponding fields of the form.

In several embodiments, at block 310, the processing logic can pre-populate the one or more values in response to determining that the local non-volatile memory comprises the data item containing the one or more values previously entered into corresponding fields of the form. For example, in response to determining that the non-volatile memory comprises the data item containing a UUID previously assigned and automatically entered into the corresponding fields of the form to identify the specified public user's session, the processing logic can, at block 310 pre-populate the UUID value into the corresponding field of the form.

As noted above, in these and other embodiments, at block 304, the processing logic can access the MDB 204 to retrieve corresponding stored link profile configuration settings in response to receiving a link profile request communicated, at block 302, via a secure connection from an Administrative User Device (AUD) 206 to create or modify a specified content link, and can, at block 305 send the configuration data back to the AUD 206. In various embodiments, the corresponding stored link profile configuration settings comprise two or more data categories, the data categories selected from a list comprising branding data, LRS 218 configuration data, xAPI verb mapping data, form field configuration data, and content metadata.

In some embodiments, at block 303, the processing logic can receive a submission from the AUD, and can, at block 307 determine whether the submission includes an upload of digital content or a link to external content. Then, at block 309, the processing logic can upload content to a Content Storage Device (CSD) 208 in response to content submission from the AUD 206, or alternatively, the processing logic can store an external content link in the MDB 204 in response to an external content link submission from the AUD 206. In either case, the processing logic can then, at block 312, generate the specified content link associated with the two or more data categories in response to completion of the link profile configuration by the AUD.

In some embodiments, the processing logic can, at block 314, transmit instructions to the PUD 210 for accessing the digital content while in other embodiments, the processing logic can, at block 314, directly access the digital content. Consequently, the processing logic can, at block 316, monitor and detect events as they occur during content interaction (i.e., when a user interacts with the digital content). For example, the processing logic can execute an Event Tracking Listener to monitor and detect events as they occur during content interaction. In these and other embodiments, the processing logic can, at block 318, transmit the detected events into xAPI statements based on xAPI verb mappings specified in the link profile configuration settings. For example, the processing logic can execute a Recipe Translator (e.g., on the PUD 210) to translate the detected events into xAPI statements based on xAPI verb mappings specified in the link profile configuration settings. Then, at block 320, the processing logic can transmit the xAPI statements to an LRS 218. For example, the processing logic can cause the xAPI statements to be transmitted from the PUD 210 to a Learning Record Store (LRS) 218 for storage and reporting. In these and other embodiments, at block 322, the processing logic can request the LRS 218 to acknowledge the receipt of the xAPI statements and to store the xAPI statements in a data repository.

In some embodiments, the processing logic (e.g., of a processing device) can perform operations encoded as instructions on a non-transitory machine-readable storage medium (i.e., instructions that, when accessed by a processing device, cause the processing device to perform the following instructions). For example, the processing logic can access a Managed Database (MDB) 204 to retrieve corresponding stored link profile configuration settings and can cause a form to be dynamically generated based on the link profile configuration settings. In these and other embodiments, the processing logic can determine whether a local non-volatile memory location associated with a browser of a Public User Device (PUD) 210 comprises a data item containing one or more values previously entered into corresponding fields of the form, and can pre-populate the form with the one or more values in response to determining that the local non-volatile memory comprises the data item containing the one or more values previously entered into corresponding fields of the form.

In several embodiments, the processing logic can generate the form in response to receiving a content link request from the PUD 210, where the form comprises a plurality of form fields, and can associate at least one value with a specified public user's session for content associated with a specified content link. The processing logic can also process form input data and use the at least one value to associate the form input data with the specified public user's session for tracking interactions with the content. In some embodiments, the processing logic can retrieve content from either a Content Storage Device (CSD) or a Content Delivery Network (CDN) in response to form submission by the PUD 210, and can monitor and detect events during content interaction through an Event Tracking Listener executed on the PUD 210. In these and other embodiments, the processing logic can receive event data for each event, where the event data includes interaction type, timestamp, and any relevant metadata. The processing logic can also translate the detected events using a Recipe Translator, where the Recipe Translator maps each event to a predefined xAPI verb and combines it with the one or more values to generate a complete xAPI statement. In some embodiments, the processing logic can then store the xAPI statement in a Learning Record Store (LRS) 218, and in response to receiving the xAPI statement, cause the LRS 218 to acknowledge receipt and store the xAPI statement in its data repository.

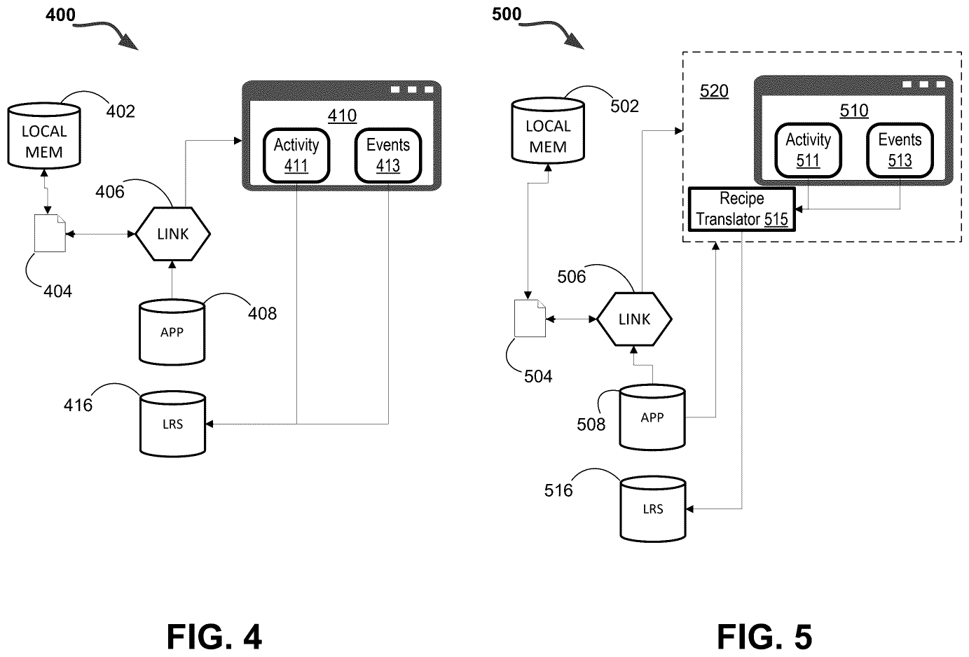

Additional details and aspects of the various implementations and embodiments of the present invention can be further understood with reference to FIGS. 4-5 which depict example content launching and interaction tracking processes and with continued reference to FIGS. 1-2.

FIG. 4 shows a schematic block diagram of an example content launching and interaction tracking process 400 in a system. In some embodiments, a networked system for dynamically creating content links and tracking content usage is implemented within an application platform 408. This system can include several stages to facilitate the creation and distribution of content links. Initially, the system can cause an Administrative User Device (AUD) to create a link profile in the Managed Database (MDB) 204. This link profile holds the configuration data necessary for multiple content links, including branding data, form field settings, and Learning Record Store (LRS) configurations. The system can also allow the AUD to specify various aspects of the link profile, including configuring branding logos, selecting the appropriate LRS for storing event data, and defining the xAPI verb recipe that translates user interactions into xAPI statements.

In these and other embodiments, the AUD can further configure the link profile by setting up data collection fields in the dynamically generated form 404. These fields, such as name, email, and user ID, allow for the collection of specific user data before the user navigates to the content 410. The system enables customization of these fields, including whether they are mandatory or optional and specifying the data type. Once the link profile is established, the system can generate a new content link. The AUD can add metadata to the link 406, including a title and description, and the link 406 can be either to uploaded content or to external sources, both of which are stored in the MDB 204.

In several embodiments, when the Public User Device (PUD) 210 interacts with the link 406, the system dynamically generates a form 404 based on the link profile settings stored in the MDB 204. The system retrieves the branding, LRS configurations, and field configurations and populates the form accordingly. The PUD 210 can then submit data through the form 404, and the system can use local storage 402 to recall previous entries, streamlining the process for the user.

Upon submission, the system can track interactions (i.e., user activity 411 and content events 413) with the content 410 using xAPI statements. The PUD 210, through an Event Tracking Listener, monitors the user's interactions with the content 410 and translates them into xAPI statements using the xAPI verb mappings configured in the link profile. The system can then transmit these xAPI statements to the LRS 416 for storage and analysis, thereby allowing the administrative user to track and analyze user engagement with the content 410.

In some embodiments, the system supports two primary types of content, which are configured when the content is either uploaded or linked to the networked system. The first type is xAPI-enabled content 410, typically authored in software that supports export as xAPI-enabled for integration with commercial learning management systems (LMS). This content type has built-in mechanisms to prepare and send xAPI statements to the Learning Record Store (LRS), but it requires specific parameters in the launch URL to complete the setup and enable subsequent transactions. The required parameters, that are provided by the application 408, include the LRS endpoint, the LRS login credentials or a URL for authenticating with the LRS, and the authentication data for the xAPI statement, known as the “actor.”

In these embodiments, the system can launch the xAPI-enabled content directly by passing the required information to the content in a manner that adheres to the xAPI standard. The xAPI functionality embedded within the content has predefined xAPI verbs and xAPI objects, which are used to generate xAPI statements. The content utilizes the LRS and actor data provided during launch to populate and send these statements. The xAPI verbs used in these statements are configured in the content and may be adjusted using the content's authoring tool or by modifying the content's source code.

In some embodiments, the second type of content lacks a built-in mechanism to send xAPI statements. FIG. 5 shows a schematic block diagram of an example content launching and interaction tracking process in a system 500, in one such embodiment. In such cases, the system 500 can employ a “wrapper” 520 to manage the interaction between the content 510 and the LRS 516. The wrapper is launched with parameters that identify the content link 506 being requested, along with data collected from the user. When the wrapper 520 is rendered, it requests data for the corresponding link 506 from the system, including the xAPI verb recipe, LRS endpoint, and authentication details. Once the wrapper is initiated, it can navigate to the content 510 and collect interaction data, which is subsequently translated into xAPI statements using the xAPI recipe provided by the system.

For non-xAPI-enabled content, the wrapper tracks and translates user events into xAPI statements. These events, triggered during user interactions with the content, are captured by the wrapper and mapped to xAPI verbs using the predefined xAPI recipe provided by that application 508. The wrapper then combines the xAPI verb, actor data (collected via the form 504), and object data to assemble the xAPI statement, which is sent to the LRS 516 for storage and analysis.

The actor data fields, which collect data from the end user, are configurable by the administrative user creating the content link and profile. These fields may include, for example, the user's first name, last name, email address, user ID, or a randomly generated ID. The administrative user can decide which fields will be visible to the end user, which will be required or optional, and what data types will be accepted. In these embodiments, any data entered by the end user is stored in the browser's local storage 502 for future use, allowing previously entered data to be recalled when the same user revisits an XCL form 504. The system provides a mechanism for clearing this data, either by clearing the browser's cache or using a “Clear form” button.

The random ID field operates differently from the other fields, as it is not visible or interactive for the end user. The system generates a random, UUID-formatted, alphanumeric string to populate this field automatically. This random string is stored in the browser's local storage 502 and recalled on subsequent visits to the XCL form 504, avoiding the generation of a new random ID. This mechanism allows administrators to track unique visitors without collecting personally identifiable information (PII).

In some embodiments, the system includes a Recipe Translator 515, which provides users the ability to configure and customize which user events are translated into specific xAPI verbs. This allows the administrative user to generate xAPI statements using a predefined “recipe” that optimizes the usefulness of the data sent to the LRS 516 for analysis and reporting. Events captured by the wrapper 520 can include standard browser events or custom events, such as a user clicking a video play button. These events are then translated into xAPI statements by the Recipe Translator 515 and sent to the LRS 516 for storage and future analysis

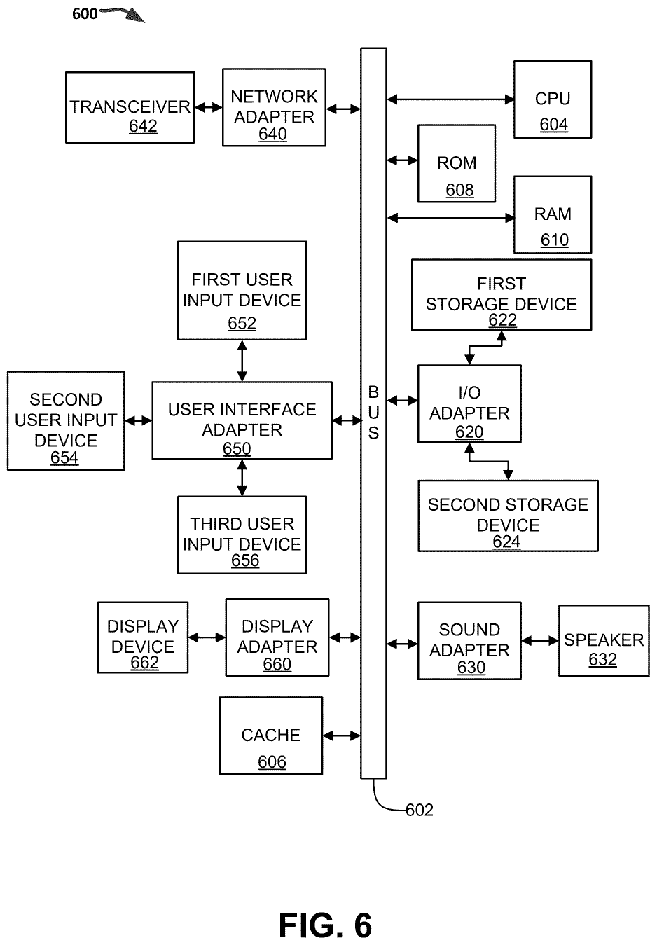

As noted earlier, the methods described above as well as the example web-interface based system can be implemented on a variety of computing devices or machines. An illustrative representation of an example computing device/processing system in accordance with an embodiment of the present disclosure is shown in FIG. 6. With continued reference to FIGS. 1-2, any one of server 103, a server of cluster 113, laptop 110, personal computer 108, 106, 112, smart phone 109, tablet 111, AS 202, AUD 206, or PUD 210, in the various embodiments described herein, be computing device 600. The computing device 600 can generally include a Central Processing Unit (CPU) 604 operatively coupled to other components via a system bus 602, optional further processing units including a graphics processing unit (GPU), a cache, a Read Only Memory (ROM) 608, and a Random Access Memory (RAM) 610. The computing device 600 can also include an input/output (I/O) adapter 620, a sound adapter 630, a network adapter 640, a user interface adapter 650, and a display adapter 660, all of which can be operatively coupled to the system bus 602.

Additionally, a first storage device 622 and a second storage device 624 can be operatively coupled to system bus 602 by the I/O adapter 620. The storage devices 622 and 624 can be any of a disk storage device (e.g., a magnetic or optical disk storage device), a solid state magnetic device, and so forth. It should be appreciated that the storage devices 622 and 624 can be the same type of storage device or different types of storage devices. In instances where the device 600 is embodied by a smart speaker 114 or the like, it can incorporate a speaker 632 which can be operatively coupled to system bus 602 by the sound adapter 630. A transceiver 642 can be operatively coupled to system bus 602 by network adapter 640. In instances where the device 600 is embodied by a laptop 110 or a smart phone 109, it can include a display device 662 which can operatively coupled to system bus 602 by display adapter 660.

In some embodiments, the device 600 can include a mother board, alternatively/additionally a different storage medium (e.g., hard disk drive, solid state drive, flash memory, cloud storage), an operating system, one or more application software and one or more input/output devices/means, including one or more communication interfaces (e.g., RS232, Ethernet, WiFi, Bluetooth, USB, etc.) Useful examples of applicable devices for use in embodiments of the present disclosure include, but are not limited to, personal computers, smart phones, laptops, mobile computing devices, tablet PCs, and servers. Multiple computing devices can be operably linked to form a computer network in a manner so as to distribute and share one or more resources, such as clustered computing devices and server banks/farms.

Accordingly, in some embodiments a first user input device 652, a second user input device 654, and a third user input device 656 can be operatively coupled to system bus 602 by user interface adapter 650. The user input devices 652, 654, and 656 can be any of a keyboard, a mouse, a keypad, an image capture device (e.g., a camera), a motion sensing device, a microphone, a touch-sensitive device (e.g., a touch screen or touchpad), a device incorporating the functionality of at least two of the preceding devices, and so forth. Of course, other types of input devices can also be used, while remaining within the scope and spirit of the present disclosure. The user input devices 652, 654, and 656 can be the same type of user input device or different types of user input devices. The user input devices 652, 654, and 656 can be used to input and output information to and from system 600.

Thus, the inputs and information discussed above can be obtained from a user via input fields, prompts, and questions via the input means of example device 600 and the information of the converted file discussed above can be presented to the user via the output means of example device 600 in accordance with the embodiments of the present disclosure. Whether visually via a display device 662, audibly via speaker 632, or through a combination of both, a user can be prompted to respond to questions, enter input, upload multi-format files, or make selections in accordance with an embodiment of the present disclosure. Accordingly, whether through tactile, audio, or video input through input devices 652, 654, and 656 a user can provide the input and selections to interact with the various elements and aspects of the present disclosure to provide the information used for the analysis and evaluation of the submission.

Of course, the processing system/device 600 can also include other elements (not shown), as readily contemplated by one of skill in the art, as well as omit certain elements. For example, various other input devices and/or output devices can be included in processing system 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 600 are readily contemplated by one of ordinary skill in the art given the teachings of the embodiments provided herein. Similarly, other variations of computer systems can likewise be incorporated in the various embodiments of the repent disclosure.

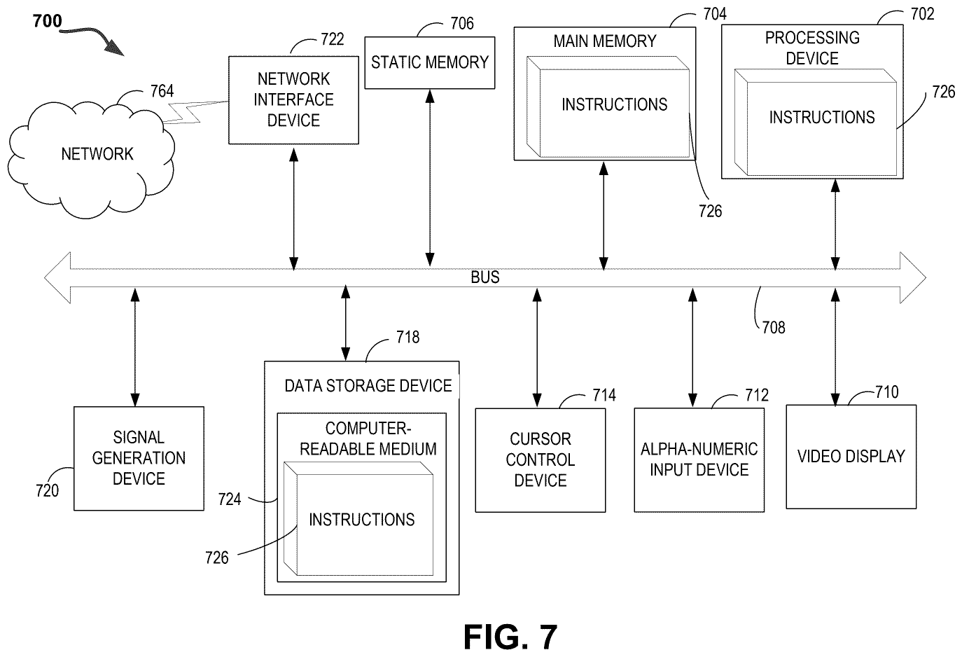

FIG. 7 depicts a block diagram of a computer system operating in accordance with one or more aspects of the disclosure. In various illustrative embodiments, computer system 700 can correspond to any one of any one of server 103, a server of cluster 113, laptop 110, personal computer 108, 106, 112, smart phone 109, tablet 111, AS 202, AUD 206, or PUD 210 of FIGS. 1-2. In some embodiments, computer system 700 can be a virtual computing system or a physical computing system. The computer system can be included within a data center that supports virtualization and distributed computing. Virtualization within a data center results in a physical system being virtualized using virtual machines to consolidate the data center infrastructure and increase operational efficiencies. A virtual machine (VM) can be a program-based emulation of computer hardware. For example, the VM can operate based on computer architecture and functions of computer hardware resources associated with hard disks or other such memory. The VM can emulate a physical computing environment, but requests for a hard disk, memory, or access to other physical resources, can be managed by a virtualization layer of a computing device to translate these requests to the underlying physical computing hardware resources so that they can be emulated as well. This type of virtualization can result in multiple VMs sharing physical resources.

In certain implementations, computer system 700 can be connected (e.g., via a network, such as a Local Area Network (LAN), an intranet, an extranet, or the Internet) to other computer systems. Computer system 700 can operate in the capacity of a server or a client computer in a client-server environment, or as a peer computer in a peer-to-peer or distributed network environment. Computer system 700 can be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein. Analogously, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (e.g., processor) 702, a main memory (memory device) 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 718, which can communicate with each other via a bus 708.

Processor (i.e., processing device) 702 represents one or more general-purpose processing devices such as a microprocessor, central processing unit, or the like. More particularly, the processor 702 can be a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets. The processor 702 can also be one or more special-purpose processing devices such as and application specific integrated circuit (ASIC), a field programmable gate array (FPGA), a digital signal processor (DSP), network processor, or the like. The processor 702 can be configured to execute instructions 726 for performing the operations discussed herein (e.g., for method 300 dynamically creating digital content links and for distributing and tracking digital content in a networked system).

Computer system 700 can further include a network interface device 722 connected to a network 764. Computer system 700 also can include a video display unit 710 (e.g., a liquid crystal display (LCD)), an alphanumeric input device 712 (e.g., a keyboard, a motion sensing input device, touch screen), a cursor control device 714 (e.g., a mouse), and a signal generation device 720 (e.g., a speaker). Data storage device 718 can include a non-transitory computer-readable storage medium 724 on which can store the instructions 726 encoding any one or more of the methods or functions described herein (e.g., method 300), including instructions for implementing the multi-format proposal evaluation and analysis. Instructions 726 can also reside, completely or partially, within volatile memory 704 and/or within processing device 702 during execution thereof by computer system 700, hence, main memory (volatile memory) 704 and processing device 702 can also constitute machine-readable storage media.

In some implementations and embodiments, the instructions 726 can include instructions for dynamically creating digital content links and for distributing and tracking digital content in a networked system. While the computer-readable storage medium 724 (machine-readable storage medium) is shown in an example implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media. Other computer system designs and configurations can also be suitable to implement the system and methods described herein. The foregoing examples illustrate various implementations in accordance with one or more aspects of the present disclosure.

Aspects of the various embodiments are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

Throughout this specification and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which can be generally referred to herein as a “component”, “module,” or “system.”

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

It will be appreciated that computer program instructions can include computer executable code. The functions, systems, and methods herein described could be utilized and presented in a multitude of languages. Individual systems can be presented in one or more languages and the language can be changed with ease at any point in the process or methods described above. One of ordinary skill in the art would appreciate that there are numerous languages the system could be provided in, and embodiments of the present disclosure are contemplated for use with any language. Computer readable program instructions for carrying out operations of the present disclosure can be assembler instructions, instruction-set-architecture (ISA) instructions, machine instructions, machine-dependent instructions, microcode, firmware instructions, state-setting data, or either source code or object code written in any combination of one or more programming languages, including a functional programming language such as Python, an object-oriented programming language such as SMALLTALK, C++ or the like, and conventional procedural programming languages, such as the “C” programming language or similar programming languages. A variety of languages for expressing computer program instructions are possible, including without limitation, Java, JavaScript, assembly language, Lisp, HTML, Perl, Swift, Ruby, Kotlin, Rust, Go, TypeScript, MATLAB, R, Scala, Erlang, Clojure, F#, Julia, Haskell, Objective-C, Lua, and Dart. Such languages can include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described. In the context of the embodiments described herein, the terms “causing” or “causes” are intended to encompass a range of interactions between components within a system. Specifically, when one component is described as causing another component to perform an action, this includes scenarios where the first component instructs, directs, commands, or otherwise induces the second component to execute a particular function or operation. This terminology is intended to encompass both direct and indirect interactions, where the first component may directly initiate an action through explicit commands, or it may set conditions or parameters that lead the second component to act. Furthermore, “causing” may also include the triggering of actions through a series of intermediary steps or components, such that the overall result is initiated by the originating component. The use of the terms “causing” or “causes” in this context is intended to cover various implementations, including those where actions are performed automatically or programmatically as a result of predefined logic or interactions within the described embodiments.

The functions and operations of the embodiments presented herein are not inherently limited to any particular computing device or other apparatus. Various general-purpose systems can also be used with programs in accordance with the teachings herein, or it can prove convenient to construct more specialized apparatus to perform the required method steps. Within this field, the configuration and management of large networks include storage devices and computing devices that are communicatively coupled to dissimilar computing and storage devices over a network, such as the Internet, also referred to as “web” or “world wide web”.

Aspects of the present disclosure can be provided as a computer program product that can include a machine-readable medium having stored thereon instructions, which can be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

Reference in this specification to “one embodiment” or “an embodiment” of the present disclosure, as well as other variations thereof, means that a particular feature, structure, characteristic, and so forth described in connection with the embodiment is included in at least one embodiment of the present disclosure. Thus, the appearances of the phrase “in one embodiment” or “in an embodiment”, as well any other variations, appearing in various places throughout the specification are not necessarily all referring to the same embodiment.

Having described preferred embodiments of a system and method (which are intended to be illustrative and not limiting), it is noted that modifications and variations can be made by persons skilled in the art in light of the above teachings. It is therefore to be understood that changes can be made in the particular embodiments disclosed which are within the scope of the present disclosure as outlined by the appended claims.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner. In certain implementations, not all operations or sub-operations of the methods herein are required to be performed.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that aspects of the present disclosure may be practiced without these specific details. In some instances, well-known structures and devices are shown in block diagram form, rather than in detail, in order to avoid obscuring the present disclosure.

Unless specifically stated otherwise, as apparent from the following discussion, it is appreciated that throughout the description, discussions utilizing terms such as “receiving,” “identifying,” “displaying,” “obtaining,” “creating,” “generating,” “mapping,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the specific purpose of analyzing and evaluating submissions, or it can comprise a general-purpose computer selectively activated or reconfigured by a computer program stored in the computer. Such a computer program can be stored in a computer readable storage medium, such as, but not limited to, any type of disk including floppy disks, optical disks (such as Blu-Ray disks, DVDs), CD-ROMs, and magnetic-optical disks, solid-state drives (SSDs), flash memory devices (including USB flash drives and SD cards), read-only memories (ROMs), random access memories (RAMs), dynamic random access memories (DRAMs), synchronous dynamic random access memories (SDRAMs), electrically erasable programmable read-only memory (EEPROMs), magnetoresistive random-access memories (MRAMs), ferroelectric RAM (FRAM), Phase-change memory (PCM), optical cards, and cloud storage services, or any type of media suitable for storing electronic instructions, each coupled to a computer system bus. Furthermore, emerging storage technologies that provide enhanced data retention and retrieval capabilities, such as three-dimensional (3D) XPoint and other non-volatile memory technologies, are also contemplated.

The words “example” or “exemplary” are used herein to mean serving as an example, instance, or illustration. Any aspect or design described herein as “example” or “exemplary” is not to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Moreover, use of the term “an embodiment” or “one embodiment” or “an implementation” or “one implementation” throughout is not intended to mean the same embodiment or implementation unless described as such. Accordingly, reference throughout this specification to “one implementation,” “an implementation,” “one embodiment,” or “an embodiment” means that a particular feature, structure, or characteristic described in connection with the respective implementations or embodiments is included in at least one implementation or embodiment. Thus, the appearances of the phrase “in one implementation,” “in an implementation,” “in an embodiment,” or “in and implementation” in various places throughout this specification can, but are not necessarily, referring to the same implementation or embodiment, depending on the circumstances. Furthermore, the particular features, structures, or characteristics may be combined in any suitable manner in one or more implementations. Furthermore, the terms “first,” “second,” “third,” “fourth,” etc. as used herein are meant as labels to distinguish among different elements and may not have an ordinal meaning according to their numerical designation.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collected data is anonymized prior to performing any analysis to obtain any statistical patterns so that the identity of the user cannot be determined from the collected data.

What is claimed is:

1. A networked system for dynamically creating digital content links and for distributing and tracking digital content, the networked system comprising:
an Application Server (AS) communicatively connected to an Administrative User Device (AUD), a Public User Device (PUD), a Content Storage Device (CSD), a Managed Database (MDB), and a Learning Record Store (LRS);
wherein:
the AS accesses the MDB to retrieve stored link profile configuration settings;
the AS causes a form to be generated dynamically based on the link profile configuration settings;
the AS causes the PUD to determine whether or not a local non-volatile memory location associated with a browser of the PUD comprises a data item comprising one or more values previously respectively entered into one or more corresponding fields of the form;
responsive to determining that the local non-volatile memory location associated with a browser of the PUD comprises the data item containing the one or more values previously entered into corresponding fields of the form, the AS causes the PUD to pre-populate the one or more corresponding fields with the one or more values respectively;
the AS causes the PUD to retrieve the digital content from a location identified by a specified content link;
the AS causes the PUD to monitor and detect events as they occur during content interaction; and
the AS transmits xAPI verb mappings specified in the link profile configuration settings for the PUD to translate the detected events into xAPI statements and transmit them to the LRS.

2. The networked system of claim 1, wherein:
the AS accesses the MDB to retrieve corresponding stored link profile configuration settings in response to receiving a link profile request communicated via a secure connection from an AUD to create or modify the specified content link; and
the AS sends configuration data back to the AUD.

3. The networked system of claim 2, wherein:
the corresponding stored link profile configuration settings comprise two or more data categories, the data categories selected from a list comprising branding data, LRS configuration data, xAPI verb mapping data, form field configuration data, and content metadata.

4. The networked system of claim 3, wherein:
in response to digital content submission from an AUD, the AS uploads corresponding content to the CSD;
in response to an external content link submission from an AUD, the AS stores the external content link in the MDB; and
in response to a completion of link profile configuration adjustment by the AUD, the AS generates the specified content link associated with the two or more data categories.

5. The networked system of claim 1, wherein:
the AS causes the form to be generated in response to receiving a content link request from the PUD; and
the form comprises a plurality of form fields.

6. The networked system of claim 1, wherein:
wherein at least one value is associated with a specified public user's session for content associated with the specified content link; and
the AS causes the PUD to process form input data and to use the at least one value to associate the form input data with the specified public user's session for tracking interactions with the content.

7. The networked system of claim 1, wherein:
in response to form submission by the PUD, the AS transmits instructions to the PUD for retrieving the digital content from either the CSD or a Content Delivery Network (CDN);
the AS causes the PUD to execute Event Tracking Listener to monitor and detect the events;
the AS causes the PUD to transmit event data for each event to the LRS, wherein the event data includes a unique user identifier, interaction type, timestamp, and any relevant metadata; and
the AS causes the PUD to execute Recipe Translator to translate the detected events, wherein the Recipe Translator, maps each event to a predefined xAPI verb and combines it with the one or more values, including the unique user identifier, to generate a complete xAPI statement.

8. The networked system of claim 1, wherein:
the AS causes the PUD to use the LRS for storing and managing user interaction data related to the digital content; and
the AS causes the PUD to request the LRS to acknowledge receipt of the xAPI statements in response to receiving the xAPI statements and to store the xAPI statements in a data repository.

9. A method for dynamically creating digital content links and for distributing and tracking digital content in a networked system, the method comprising:
accessing, by an Application Server (AS), a Managed Database (MDB) to retrieve corresponding stored link profile configuration settings;
causing, by the AS, a form to be dynamically generated based on the link profile configuration settings;
causing a Public User Device (PUD) to determine whether a local non-volatile memory location associated with a browser of the PUD comprises a data item containing one or more values previously entered into corresponding fields of the form; and
causing, by the AS, the form to be pre-populated by the PUD with the one or more values in response to determining that the local non-volatile memory comprises the data item containing the one or more values previously entered into corresponding fields of the form.

10. The method of claim 9, further comprising:
accessing, by the AS, the MDB to retrieve corresponding stored link profile configuration settings in response to receiving a link profile request communicated via a secure connection from an Administrative User Device (AUD) to create or modify a specified content link; and
sending, by the AS, configuration data back to the AUD.

11. The method of claim 10, wherein the corresponding stored link profile configuration settings comprise two or more data categories, the data categories selected from a list comprising branding data, LRS configuration data, xAPI verb mapping data, form field configuration data, and content metadata.

12. The method of claim 11, further comprising:
uploading, by the AS, content to a Content Storage Device (CSD) in response to content submission from the AUD;
storing, by the AS, an external content link in the MDB in response to an external content link submission from the AUD; and
generating, by the AS, the specified content link associated with the two or more data categories in response to completion of the link profile configuration by the AUD.

13. The method of claim 9, further comprising:
transmitting, by the AS, instructions to the PUD for accessing the digital content by the PUD;
causing, by the AS, and Event Tracking Listener to be executed on the PUD to monitor and detect events as they occur during content interaction; and
causing, by the AS, a Recipe Translator to be executed on the PUD to translate the detected events into xAPI statements based on xAPI verb mappings specified in the link profile configuration settings.

14. The method of claim 13, further comprising:
by the AS, the xAPI statements to be transmitted from the PUD to a Learning Record Store (LRS) for storage and reporting.

15. A non-transitory machine-readable storage medium comprising instructions that, when accessed by a processing device, cause the processing device to:
access a Managed Database (MDB) to retrieve corresponding stored link profile configuration settings;
cause a form to be dynamically generated based on the link profile configuration settings;
determine whether a local non-volatile memory location associated with a browser of a Public User Device (PUD) comprises a data item containing one or more values previously entered into corresponding fields of the form; and
pre-populate the form with the one or more values in response to determining that the local non-volatile memory comprises the data item containing the one or more values previously entered into corresponding fields of the form.

16. A non-transitory machine-readable storage medium of claim 15, further comprising instructions that, when accessed by the processing device, cause the processing device to:
generate the form in response to receiving a content link request from the PUD; and
wherein the form comprises a plurality of form fields.

17. The non-transitory machine-readable storage medium of claim 16, further comprising instructions that, when accessed by the processing device, cause the processing device to:
associate at least one value with a specified public user's session for content associated with a specified content link; and
process form input data and use the at least one value to associate the form input data with the specified public user's session for tracking interactions with the content.

18. The non-transitory machine-readable storage medium of claim 15, further comprising instructions that, when accessed by the processing device, cause the processing device to:
retrieve content from either a Content Storage Device (CSD) or a Content Delivery Network (CDN) in response to form submission by the PUD;
monitor and detect events during content interaction through an Event Tracking Listener executed on the PUD; and
receive event data for each event, wherein the event data includes interaction type, timestamp, and any relevant metadata.

19. The non-transitory machine-readable storage medium of claim 18, further comprising instructions that, when accessed by the processing device, cause the processing device to:
Translate the detected events using a Recipe Translator, wherein the Recipe Translator maps each event to a predefined xAPI verb and combines it with the one or more values to generate a complete xAPI statement.

20. The non-transitory machine-readable storage medium of claim 19, further comprising instructions that, when accessed by the processing device, cause the processing device to:
store the xAPI statement in a Learning Record Store (LRS), and in response to receiving the xAPI statement, cause the LRS to acknowledge receipt and store the xAPI statement in its data repository.
